(19) United States
(12) Patent Application Publication
(10) Pub. No.: US 2011/0242292 A1
(43) Pub. Date: Oct. 6, 2011

(54) Display control unit, display control method and program

(75) Inventor: Motoki Kato, Kanagawa (JP)

(73) Assignee: Sony Corporation, Tokyo (JP)

(21) Appl. No.: 13/065,531

(22) Filed: Mar. 24, 2011

(30) Foreign Application Priority Data
Mar. 31, 2010 (JP) P2010-080518

(51) Int. Cl. H04N 13/04

(52) U.S. Cl. 348/51; 348/E13.075

(57) ABSTRACT

A display control unit includes: a determining section which determines a type of content to be reproduced when 2D content and 3D content are to be reproduced in a mixed order, the 2D content containing video data of 2D images and the 3D content containing video data of images for the left eye and images for the right eye; a setting section which, for the 2D content, displays 2D images and, for the 3D content, sets a 2D display mode to cause either the images for the left eye or the images for the right eye are displayed; a reproducing section which reproduces the content in the 2D display mode; and a display control section which, when 3D content is to be reproduced, displays type information while the content is displayed in the 2D display mode on the basis of data obtained through reproduction.

### CROSS-REFERENCE TO RELATED APPLICATION

The present application claims priority from Japanese Patent Application No. JP 2010-080518 filed in the Japanese Patent Office on Mar. 31, 2010, the entire content of which is incorporated herein by reference.

### BACKGROUND OF THE INVENTION

1. Field of the Invention
The present invention relates to a display control unit, a display control method and a program. More specifically, the present invention relates to a display control unit, a display control method and a program capable of letting a user comfortably view content even if 2D content and 3D content are broadcast in a mixed order.

2. Description of the Related Art

An increased number of pixels of, for example, a liquid crystal displays (LCDs) and an increased frame rate have implemented a new image display system: a three-dimensional (3D) display system. The 3D display system provides the audience with stereoscopic vision of objects.

In the following description, images with stereoscopic vision of objects will be called “3D images” and content which contains video data for displaying 3D images will be called “3D content.” Normal planar images with no stereoscopic vision of objects will be called “two-dimensional (2D) images” and content which contains no video data for displaying 3D images will be called “2D content.”

An exemplary 3D image display system is a frame sequential system in which images for the left eye (L images) and images for the right eye (R images) with parallax are displayed alternately. The L images and the R images are respectively delivered to the right and left eyes of a viewer who wears 3D active shutter glasses, thereby providing the viewer with stereoscopic vision.

Japanese Unexamined Patent Application Publication No. 2007-36528 discloses a technique to insert, in stereoscopic image data, an encoded identification mark indicating an image as being a stereoscopic image.

### SUMMARY OF THE INVENTION

In the future, it is possible that 3D content programs (3D programs) would be broadcast. It is also possible that not all the programs to be broadcast would be 3D programs but 3D programs and 2D content programs (2D programs) would be broadcast in a mixed order.

FIG. 1 illustrates an exemplary display of a television receiver in a case in which 2D programs and 3D programs are broadcast in a mixed order.

An upper half of FIG. 1 illustrates programs broadcast on a channel: channel A. In the example of FIG. 1, a 2D program A is broadcast between time t1 and time t2, a 3D program A is broadcast between time t2 and time t3 and a 2D program B is broadcast between time t3 and time t4.

The 3D program A is content which contains video data encoded in, for example, an H.264 advanced video coding/multi-view video coding (AVC/MVC) system as data for displaying 3D images. In the video data contained in the 3D program A, L image frames and R image frames are arranged alternately in the order to be displayed. For example, the L images and the R images are of full resolution (1920×1080 pixels).

The lower half of FIG. 1 is schematic illustration of a display of a television receiver in which each of the programs broadcast on the channel A is displayed in a 3D display mode. The display mode of the television receiver is selected from between the 3D display mode and a 2D display mode.

FIG. 2 illustrates display systems of display modes in a case in which the 3D content contains video data encoded in the H.264 AVC/MVC system.

As illustrated in FIG. 2, in the 3D display mode, if the content to be reproduced is 2D content, all the frames of the video data will be displayed sequentially. Thus, a viewer views the 2D content to be reproduced as 2D images regardless of wearing 3D active shutter glasses.

In a case in which the 3D display mode is set, if the content to be reproduced is 3D content, L image frames and R image frames, which are all the frames contained in the video data, will be displayed alternately. Thus, the viewer who wears 3D active shutter glasses views the video of the 3D content to be reproduced as 3D images.

In a case in which the 2D display mode is set, if the content to be reproduced is 2D content, all the frames of the video data will be displayed sequentially. Thus, the viewer views the 2D content to be reproduced as 2D images regardless of wearing 3D active shutter glasses.

In a case in which the 2D display mode is set, if the content to be reproduced is 3D content, only L image frames, for example, among the L image frames and the R image frames contained in the video data will be displayed. Thus, the viewer views the 3D content to be reproduced as 2D images regardless of wearing 3D active shutter glasses.

A case will be described in which the 2D program A, the 3D program A and the 2D program B illustrated in FIG. 1 are displayed in the 3D display mode. Here, the user wears no 3D active shutter glasses.

In a case in which receiving of video data on the channel A is started at the time t1, the video data is reproduced such that all the frames of the video data will be displayed for the 2D program A. The video of the 2D program A is viewed as 2D images as illustrated by a hollow arrow #1.

In a case in which broadcasting of the 2D program A is ended and broadcasting of the 3D program A is started at the time t2, the L image frames and the R image frames, which are all the frames contained in the video data, will be displayed alternately for the 3D program A.

The user, wearing no 3D active shutter glasses, views the video of the 3D program A not as 3D images but as blurred 2D images as illustrated by a hollow arrow #2. In the exemplary display of the video of the 3D program A, the two objects which are adjacent to each other represent that the L image frames and the R image frames are displayed alternately.

Since the images which have been displayed properly till then (i.e., till the time t2) suddenly become blurred, the user is surprised or supposes that the television receiver has been broken.

The same phenomenon occurs when a 3D program is displayed upon turning on of the television receiver or upon changing of the channel on the television receiver unless the user wears 3D active shutter glasses.

Like the video of the 2D program A, the video of the 2D program B is viewed as 2D images as illustrated by a hollow arrow #3.

FIG. 3 illustrates another exemplary display of a television receiver in a case in which 2D programs and 3D programs are broadcast in a mixed order. Description about the same components as those illustrated in FIG. 1 will be omitted.

In the example of FIG. 3, a 3D program B is broadcast between time t2 and time t3. The 3D program B is content which contains video data in which L images and R images are encoded in a side-by-side system or a top-and-bottom system.

In the side-by-side system, a single frame (i.e., field) is divided into right and left halves and, for example, the L images are inserted in the left half and the R images are inserted in the right half. The frames are then encoded. During decoding, the L images extracted from the left half of the frame and the R images extracted from the right half of the single frame are scaled such that their resolution is in accordance with display resolution (i.e., such that their aspect ratios are in accordance with an aspect ratio of the display) and are displayed alternately, whereby 3D images will be displayed.

In the top-and-bottom system, a single frame is divided vertically and, for example, the L images are inserted in the upper half and the R images are inserted in the lower half. The frames are then encoded. During decoding, the L images extracted from the upper half of the frame and the R images extracted from the lower half of the single frame are scaled such that their resolution is in accordance with display resolution and are displayed alternately, whereby 3D images will be displayed.

FIG. 4 illustrates display systems of display modes in a case in which the 3D content contains video data encoded in the side-by-side system or the top-and-bottom system.

In the 3D display mode, if the content to be reproduced is 3D content, all the frames of the video data will be displayed. After the L images and the R images are extracted from each frame and are scaled, the L image frames and the R image frames are displayed alternately. Thus, the viewer who wears 3D active shutter glasses views the video of the 3D content to be reproduced as 3D images.

In a case in which the 2D display mode is set, if the content to be reproduced is 3D content, all the frames of the video data will be displayed. In this case, each frame is displayed without extraction of the L images and the R images from each frame or without scaling.

In FIG. 4, the display in a case in which the content to be reproduced is 2D content is the same as that described with reference to FIG. 2.

A case will be described in which the 2D program A, the 3D program B and the 2D program B illustrated in FIG. 3 are displayed in the 2D display mode. Here, the user wears no 3D active shutter glasses.

In a case in which receiving of video data on the channel A is started at the time t1, the video data is reproduced such that all the frames of the video data will be displayed for the 2D program A. The video of the 2D program A is viewed as 2D images as illustrated by a hollow arrow #1.

In a case in which broadcasting of the 2D program A is ended and broadcasting of the 3D program B is started at the time t2, all the frames of the video data will be without extraction or scaling for the 3D program B. As illustrated by the hollow arrow #2, in the video of the 3D program B, an L image and an R image contained in a single frame are displayed at the same time.

Since the images which have been viewed properly till then suddenly divided into two and a deformed object is displayed, the user is surprised or supposes that the television receiver has been broken.

It is desirable to let a user view video of a 2D program as 2D images as usual and view video of a 3D program as 3D images properly without viewing unusual images even if 2D content and 3D content are broadcast in a mixed order.

The present invention has been made in view of aforementioned circumstances and lets a user comfortably view content even if 2D content and 3D content are broadcast in a mixed order.

A display control unit according to an embodiment of the present invention includes: a determining means for determining a type of content to be reproduced in a case in which the content to be reproduced is switched between 2D content and 3D content, the 2D content containing video data of 2D images and the 3D content containing video data of images for the left eye and images for the right eye; a setting means for, for the 2D content, 2D displaying images contained in the video data and, for the 3D content, setting a 2D display mode, in which either the images for the left eye or the images for the right eye are displayed, as a display mode of the content to be reproduced; a reproducing means for reproducing the content to be reproduced such that the content is displayed in the 2D display mode; and a display control means for, when it is determined that the type of content to be reproduced is 3D content, displaying type information which indicates that the type of the content is 3D content while the content to be reproduced is displayed in the 2D display mode on the basis of data obtained through reproduction by the reproducing means.

In response to user instructions after the type information is displayed, the setting means may be caused to set a 3D display mode in which images for the left eye and images for the right eye contained in the video data of the 3D content are displayed; the reproducing means may be caused to reproduce the content to be reproduced such that the content is displayed in the 3D display mode; and the display control means may be caused to display the images for the left eye and the images for the right eye on the basis of data obtained through reproduction by the reproducing means.

The setting means may be caused to set the 2D display mode when the reproduction of the content to be reproduced which is the 3D content ends.

The setting means may be caused to set the 2D display mode when the display control unit is turned on.

The content to be reproduced may be broadcast content and the setting means may be caused to set the 2D display mode when a channel on which the broadcast content is received is changed.

A display control method according to an embodiment of the present invention includes the steps of: determining a type of content to be reproduced in a case in which the content to be reproduced is switched between 2D content and 3D content, the 2D content containing video data of 2D images and the 3D content containing video data of images for the left eye and images for the right eye; for the 2D content, displaying 2D images contained in the video data and, for the 3D content, setting a 2D display mode, in which either the images for the left eye or the images for the right eye are displayed, as a display mode of the content to be reproduced; reproducing the content to be reproduced such that the content is displayed in the 2D display mode; and, when it is determined that the type of content to be reproduced is 3D content, displaying type information which indicates that the type of the content is 3D content while the content to be reproduced is displayed in the 2D display mode on the basis of data obtained through reproduction.

A program according to an embodiment of the present embodiment causes a computer to execute a process including the steps of: determining a type of content to be reproduced in a case in which the content to be reproduced is switched between 2D content and 3D content, the 2D content containing video data of 2D images and the 3D content containing video data of images for the left eye and images for the right eye; for the 2D content, displaying 2D images contained in the video data and, for the 3D content, setting a 2D display mode, in which either the images for the left eye or the images for the right eye are displayed, as a display mode of the content to be reproduced; reproducing the content to be reproduced such that the content is displayed in the 2D display mode; and, when it is determined that the type of content to be reproduced is 3D content, displaying type information which indicates that the type of the content is 3D content while the content to be reproduced is displayed in the 2D display mode on the basis of data obtained through reproduction.

In the embodiment of the present invention, a type of content to be reproduced is determined in a case in which the content to be reproduced is switched between 2D content and 3D content, the 2D content containing video data of 2D images and the 3D content containing video data of images for the left eye and images for the right eye, and for the 2D content, 2D images contained in the video data are displayed and, for the 3D content, a 2D display mode, in which either the images for the left eye or the images for the right eye are displayed, is set as a display mode of the content to be reproduced. The content to be reproduced is reproduced such that the content is displayed in the 2D display mode and, when it is determined that the type of content to be reproduced is 3D content, type information is displayed which indicates that the type of the content is 3D content while the content to be reproduced is displayed in the 2D display mode on the basis of data obtained through reproduction.

According to the present invention, a user can comfortably view content even if 2D content and 3D content are broadcast in a mixed order.

### BRIEF DESCRIPTION OF THE DRAWINGS

FIG. 1 illustrates an exemplary display of a television receiver in a case in which 2D programs and 3D programs are broadcast in a mixed order;

FIG. 2 illustrates display systems of display modes in a case in which the 3D content contains video data encoded in the H.264 AVC/MVC system;

FIG. 3 illustrates another exemplary display of a television receiver in a case in which 2D programs and 3D programs are broadcast in a mixed order;

FIG. 4 illustrates display systems of display modes in a case in which the 3D content contains video data encoded in the side-by-side system or the top-and-bottom system;

FIG. 5 illustrates an exemplary display of a television receiver according to an embodiment of the present invention in a case in which 2D programs and 3D programs are broadcast in a mixed order;

FIG. 6 illustrates display systems of display modes in a case in which the 3D content contains video data encoded in the H.264 AVC/MVC system;

FIG. 7 illustrates display systems of display modes in a case in which the 3D content contains video data encoded in the side-by-side system or the top-and-bottom system;

FIG. 8 is a block diagram illustrating an exemplary configuration of a television receiver;

FIG. 9 is a flowchart of a process for setting a display mode of a television receiver; and

FIG. 10 is a block diagram illustrating an exemplary configuration of computer hardware.

### DESCRIPTION OF THE PREFERRED EMBODIMENTS

### Switching of Display Mode

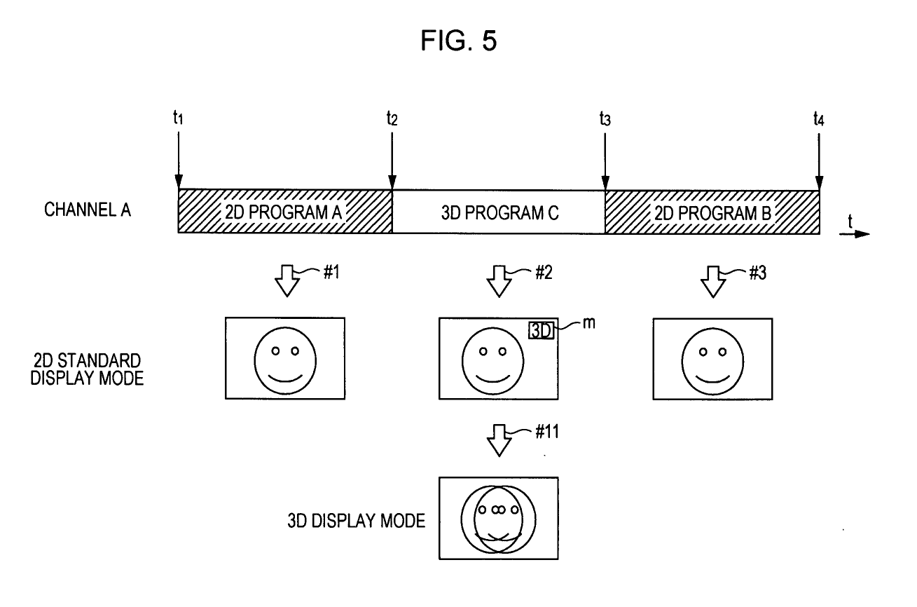

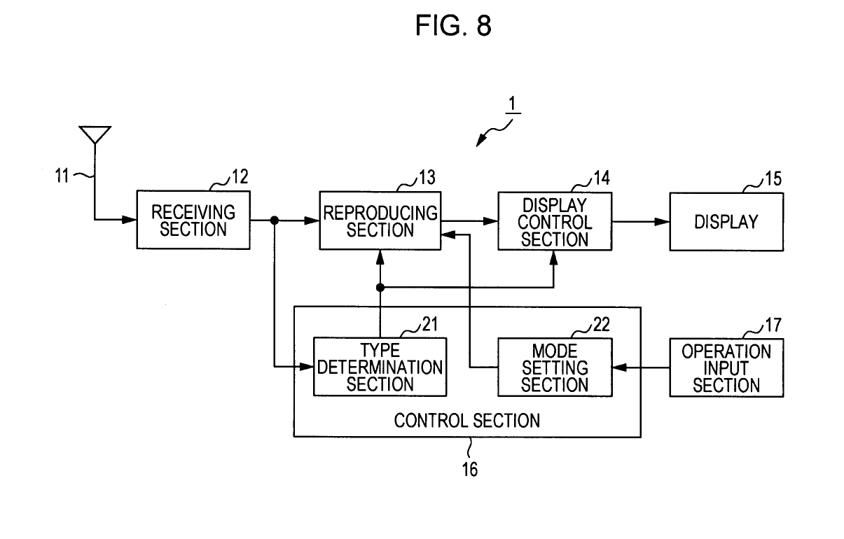

FIG. 5 illustrates an exemplary display of a television receiver 1 (see FIG. 8) according to an embodiment of the present invention in a case in which 2D programs and 3D programs are broadcast in a mixed order.

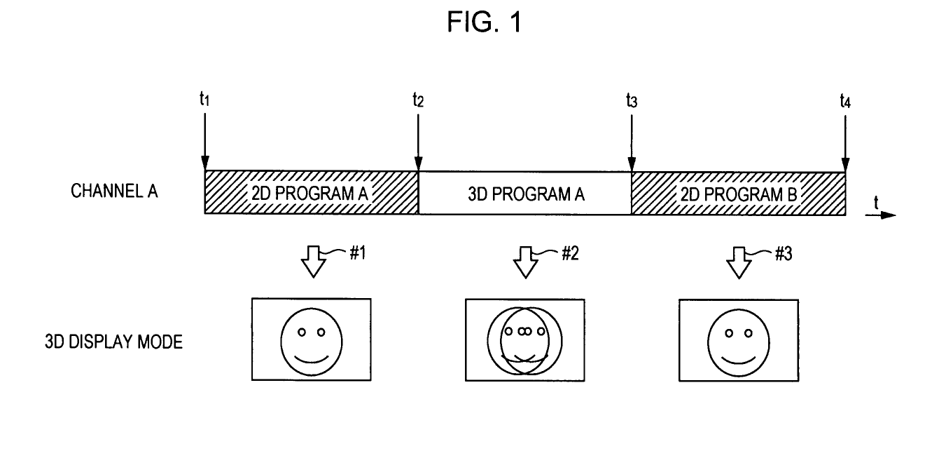

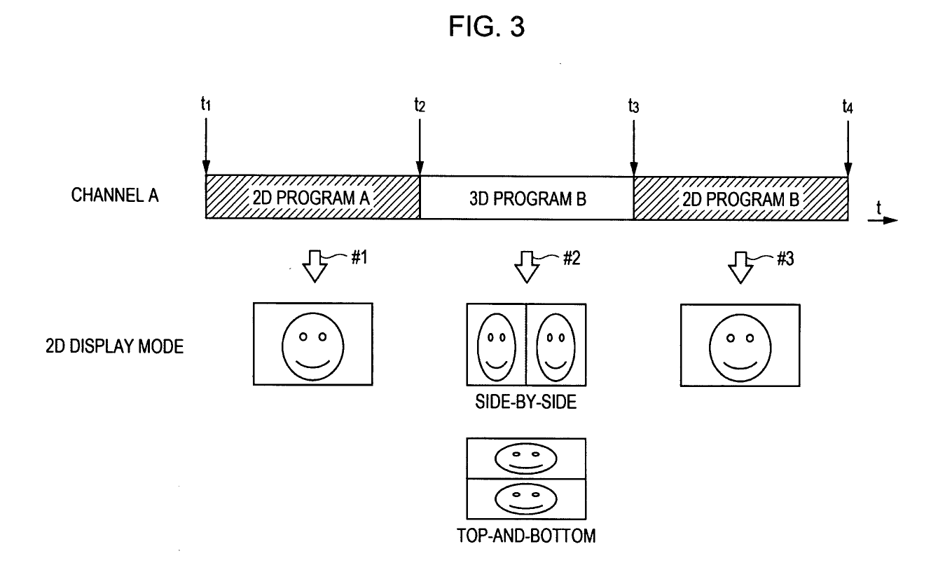

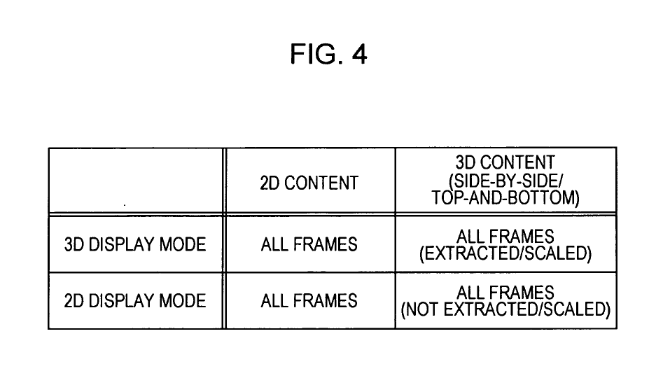

The example illustrated in FIG. 5 is substantially the same as those described with reference to FIG. 1 or FIG. 3 except for different displays of 3D programs. In the example of FIG. 5, a 2D program A is broadcast between time t1 and time t2, a 3D program C is broadcast between time t2 and time t3 and a 2D program B is broadcast between time t3 and time t4 on a channel A.

First, a case will be described in which the 3D program C contains video data encoded in a H.264 AVC system. In the video data contained in the 3D program C, L image frames and R image frames are arranged alternately in the order to be displayed. For example, the L images and the R images are of full resolution.

In a television receiver 1, a 2D display mode is selected from between a 3D display mode and the 2D display mode and is set as a default display mode of the video. The 2D display mode which is set as a default display mode will be called a 2D standard display mode. The 2D standard display mode is set when, for example, the television receiver 1 is turned on and a channel of the television receiver 1 is changed.

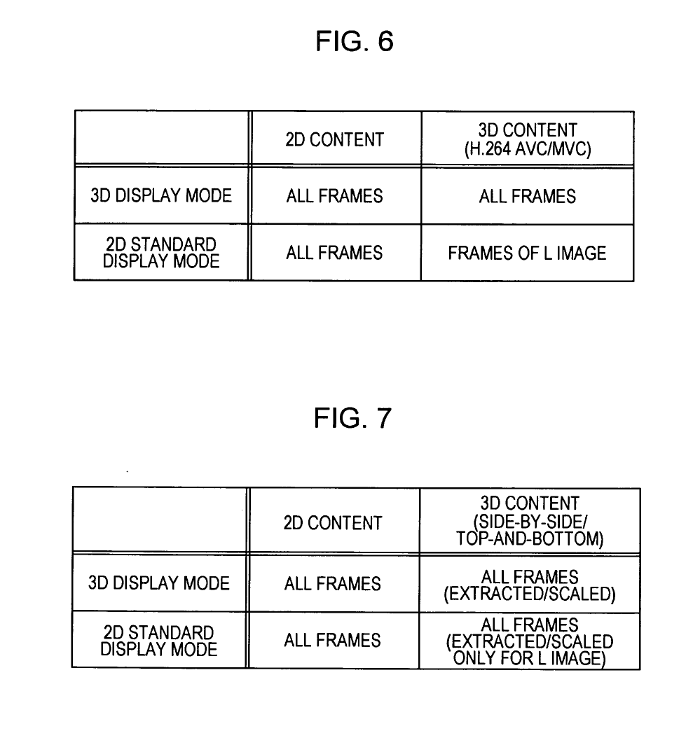

FIG. 6 illustrates display systems of display modes in a case in which the 3D content contains video data encoded in the H.264 AVC/MVC system.

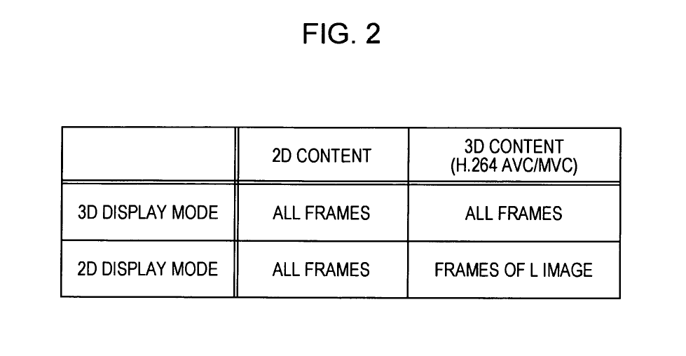

The display when the 3D display mode is set is the same as that when the 3D display mode is set as described with reference to FIG. 2. The display when the 2D standard display mode is set is the same as that when the 2D display mode is set as described with reference to FIG. 2.

As illustrated in FIG. 6, in the 3D display mode, if the content to be reproduced is 2D content, all the frames of the video data will be displayed sequentially.

In a case in which the 3D display mode is set, if the content to be reproduced is 3D content, L image frames and R image frames, which are all the frames contained in the video data, will be displayed alternately.

In a case in which the 2D standard display mode is set, if the content to be reproduced is 2D content, all the frames of the video data will be displayed sequentially.

In a case in which the 2D standard display mode is set, if the content to be reproduced is 3D content, only L image frames, for example, among the L image frames and the R image frames contained in the video data will be displayed.

A case will be described in which the 2D program A, the 3D program C and the 2D program B illustrated in FIG. 5 are displayed.

In a case in which receiving of video data on the channel A is started at the time t1 when instructions for turning on of the television receiver 1 or changing of the channel are provided, the 2D standard display mode is set as the display mode. The video data is reproduced such that all the frames of the video data will be displayed for the 2D program A. The video of the 2D program A is viewed as 2D images as illustrated by a hollow arrow #1.

In a case in which broadcasting of the 2D program A is ended and broadcasting of the 3D program C is started at the time t2, only the L image frames among the L image frames and the R image frames, which are all the frames contained in the video data, will be displayed for the 3D program C. At this time, the video of the 3D program C is viewed as 2D images.

If it is determined that the 3D program C currently being broadcast is a 3D program, a 3D mark m which is type information indicating that the program currently being broadcast is a 3D program is displayed as illustrated by a hollow arrow #2.

The 3D mark m notifies the user that the 3D program C is a 3D program. The user operates, for example, a remote controller to switch the display mode to a 3D display mode after putting 3D active shutter glasses prepared for viewing 3D images on.

When instructions for switching the display mode to the 3D display mode are provided, the display mode is switched from the 2D standard display mode to the 3D display mode in the television receiver 1. As illustrated by a hollow arrow #11, the 3D mark m disappears and the L image frames and the R image frames contained in the video data of the 3D program C will be displayed alternately.

Since the user puts the 3D active shutter glasses on after observing the 3D mark m, the user views the video of the 3D program C as 3D images.

In a case in which broadcasting of the 3D program C is ended and broadcasting of the 2D program B is started at the time t3, the video data is reproduced such that all the frames contained in the video data will be displayed for the 2D program B. The video of the 2D program B is viewed as 2D images as illustrated by a hollow arrow #3.

The display mode may be switched from the 3D display mode to the 2D standard display mode when broadcasting of the 3D program C is ended. Also in this case, the video of the 2D program B is displayed in the 2D standard display mode and is viewed as 2D images.

Since the 3D images are reproduced after instructions for switching to the 3D display mode are provided by the user, it is possible to avoid blurred video to be viewed by the user as the video of the 3D program even when the program currently being received is switched from the 2D program to the 3D program.

Next, a case in which the 3D program C illustrated in FIG. 5 contains video data encoded in a side-by-side system or a top-and-bottom system.

Also in this case, the 2D standard display mode is set when, for example, the television receiver 1 is turned on and a channel of the television receiver 1 is changed.

FIG. 7 illustrates display systems of display modes in a case in which the 3D content contains video data encoded in the side-by-side system or the top-and-bottom system.

In a case in which the 2D standard display mode is set, if the content to be reproduced is 2D content, all the frames of the video data will be displayed sequentially.

In a case in which the 2D standard display mode is set, if the content to be reproduced is 3D content, only L images, for example, from between the L images and the R images inserted in the frames contained in the video data will be extracted. The extracted L images are scaled such that their resolution is in accordance with display resolution. Then, the L images are displayed.

In FIG. 7, the display in a case in which the content to be reproduced is 2D content is the same as that described with reference to FIG. 6.

A case will be described in which the 2D program A, the 3D program C and the 2D program B illustrated in FIG. 5 are displayed.

In a case in which receiving of video data on the channel A is started at the time t1 when instructions for turning on of the television receiver 1 or changing of the channel are provided, the 2D standard display mode is set as the display mode. The video data is reproduced such that all the frames of the video data will be displayed for the 2D program A. The video of the 2D program A is viewed as 2D images as illustrated by a hollow arrow #1.

In a case in which broadcasting of the 2D program A is ended and broadcasting of the 3D program C is started at the time t2, only L images from between the L images and the R images contained in the frames of the video data will be extracted for the 3D program C. The extracted L images are scaled such that the resolution thereof is in accordance with display resolution. Then, the L image is displayed.

That is, in a case in which the video data of the 3D program C has been encoded in the side-by-side system, only L images inserted in the left half of the frames, for example, will be extracted. The extracted L images are scaled such that the resolution thereof is in accordance with display resolution. Then, the L image is displayed.

In a case in which the video data of the 3D program C has been encoded in the top-and-bottom system, only L images inserted in the upper half of the frames, for example, will be extracted. The extracted L images are scaled such that the resolution thereof is in accordance with display resolution. Then, the L image is displayed.

At this time, the video of the 3D program C is viewed as 2D images.

If it is determined that the 3D program C currently being broadcast is a 3D program, a 3D mark m is displayed over the video as illustrated by a hollow arrow #2.

When instructions for switching the display mode to the 3D display mode are provided, the display mode is switched from the 2D standard display mode to the 3D display mode. As illustrated by a hollow arrow #11, the 3D mark m disappears and the L image frames and the R image frames contained in the video data of the 3D program C will be displayed alternately.

In a case in which the video data of the 3D program C has been encoded in the side-by-side system, both L images inserted in the left half and R images inserted in the right half of the frames will be extracted. The extracted L images and R images are scaled such that the resolution thereof is in accordance with display resolution. Then, the L image and the R image are displayed alternately.

In a case in which the video data of the 3D program C has been encoded in the top-and-bottom system, both L images inserted in the upper half and R images inserted in the lower half of the frames will be extracted. The extracted L images and R images are scaled such that the resolution thereof is in accordance with display resolution. Then, the L image and the R image are displayed alternately.

In a case in which broadcasting of the 3D program C is ended and broadcasting of the 2D program B is started at the time t3, the video data is reproduced such that all the frames contained in the video data will be displayed for the 2D program B. The video of the 2D program B is viewed as 2D images as illustrated by a hollow arrow #3.

Since the 3D images are reproduced after instructions for switching to the 3D display mode are provided by the user, even if the 2D program currently being received is switched to the 3D program, it is possible to avoid the video to be viewed by the user in which the L image and the R image are displayed in a single frame and thus are showing a deformed object.

A process of the television receiver 1 for setting the display mode in the manner as described above will be described later.

### Exemplary Configuration of Television Receiver 1

FIG. 8 is a block diagram illustrating an exemplary configuration of the television receiver 1.

As illustrated in FIG. 8, the television receiver 1 includes a receiving section 12, a reproducing section 13, a display control section 14, a display 15, a control section 16 and an operation input section 17. The control section 16 is formed by a type determination section 21 and a mode setting section 22. Reception signals supplied from the antenna 11 which receives a broadcast wave are input to the receiving section 12.

The receiving section 12 performs, for example, demodulation and A/D conversion on the reception signals and generates data of the program. The receiving section 12 outputs data of the program currently being broadcast to the reproducing section 13 and to the type determination section 21.

In accordance with the display mode set by the mode setting section 22, the reproducing section 13 reproduces, in a manner as described with reference to FIG. 6 or FIG. 7, video data of the program currently being received. Information which indicates the type of the program currently being received is supplied from the type determination section 21. The reproducing section 13 outputs data of each frame obtained by the reproduction to the display control section 14. Audio data of the program is also reproduced in an unillustrated circuit and output from a speaker.

The display control section 14 causes each frame to be displayed on the display 15 in accordance with the data supplied from the reproducing section 13. The display control section 14 causes a 3D mark to be displayed on the display 15 if it is determined that the program currently being received is a 3D program on the basis of the information supplied from the type determination section 21.

The type determination section 21 of the control section 16 determines the type of the program currently being received on the basis of the data of the program supplied from the receiving section 12.

For example, the type determination section 21 determines whether the program currently being received is a 2D program or a 3D program. Alternatively, the type determination section 21 determines whether the video data of the 3D program has been encoded in the H.264 AVC/MVC system or encoded in the side-by-side system or the top-and-bottom system. The type is determined through, for example, analysis of the video data in accordance with a flag set in the video data contained in the data of the program.

The type determination section 21 outputs information which indicates the type of the program currently being received to the reproducing section 13 and to the display control section 14.

The mode setting section 22 sets the display mode of the video in accordance with the signal supplied from the operation input section 17 and outputs information about the display mode which has been set to the reproducing section 13.

For example, the mode setting section 22 sets the 2D standard display mode as the display mode when a signal representing instructions for turning on of the television receiver 1 or changing of the channel is supplied from the operation input section 17. The mode setting section 22 switches the display mode from the 2D standard display mode to the 3D display mode when a signal representing instructions for switching the display mode to the 3D display mode is supplied from the operation input section 17 after the 3D mark is displayed.

The operation input section 17 detects user operations with respect to buttons provided on a surface of a casing of the television receiver 1 or a remote controller and outputs signals indicating details of the user operations to the mode setting section 22.

### Operation of Television Receiver 1

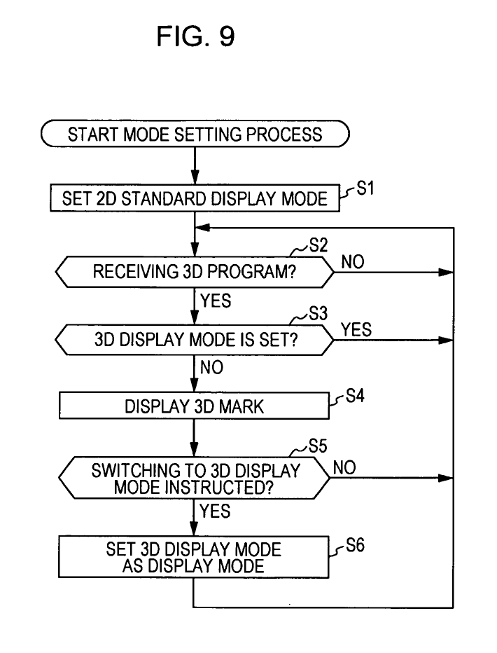

Next, a process of the television receiver 1 for setting the display mode will be described with reference to a flowchart of FIG. 9.

The process of FIG. 9 is started when instructions for turning on of the television receiver 1 or changing of the channel are provided.

In step S1, the mode setting section 22 sets the 2D standard display mode. In the reproducing section 13, the program currently being received is reproduced in the 2D standard display mode. Data of each frame obtained through the reproduction in the 2D standard display mode is supplied to the display control section 14 and each frame is displayed on the display 15. The user views the video of the program currently being received as 2D images.

In step S2, the type determination section 21 determines whether the program currently being received is a 3D program. If the determination result is negative, the type determination section 21 repeats the determination procedure until it is determined that the program currently being received is a 3D program.

If the determination result in step S2 is affirmative, the display control section 14 determines in step S3 whether the 3D display mode has been set.

If the determination result in step S3 is negative, the display control section 14 causes in step S4 a 3D mark to be displayed over the video of the program currently being received which is displayed in the 2D standard display mode.

In step S5, the mode setting section 22 determines whether instructions for switching to the 3D display mode have been provided.

If the determination result in step S5 is affirmative, the mode setting section 22 sets the 3D display mode as the display mode in step S6.

After the display mode is switched to the 3D display mode in step S6, the routine returns to step S2 and the process described above is repeated. If the determination result in step S3 is affirmative or if the determination result in step S5 is negative, the routine also returns to step S2 and the process described above is repeated.

If the determination result in step S5 is negative, the 3D mark displayed in step S4 may be caused to disappear after predetermined time elapses. The 3D mark may be displayed only once or any number of times set by the user while the same 3D program is broadcast.

With the process described above, it is possible in the television receiver 1 to avoid abnormal video to be viewed by the user as video of the 3D program when the program currently being received is switched from a 2D program to a 3D program. The user can view the 3D program comfortably.

### Modification

Although the case has been described in which display modes of broadcast programs are switched, the above-described process may also be applied to programs distributed over the Internet. The above-described process may also be applied to continuously reproduce 2D content and 3D content that are recorded in a mixed order on a recording media, such as Blu-ray (trademark) disc and hard disk.

In the above-described process, the 3D mark (which is an image) is displayed to indicate that the program currently being received is a 3D program; however, such an indication may also be made with displayed text or auditorily through a speaker.

### Exemplary Configuration of Computer

The series of process steps described above may be executed in either hardware or software. In a case in which the series of process steps described above is executed in software, a program which constitutes the software is installed in a computer incorporated in dedicated hardware or a general-purpose personal computer from a program recording medium.

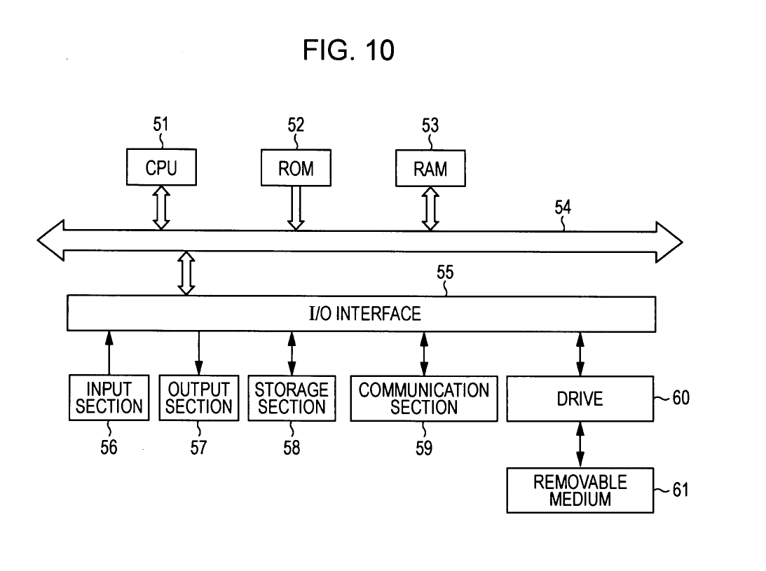

FIG. 10 is a block diagram illustrating an exemplary configuration of computer hardware which executes a series of process steps by a program.

A central processing unit (CPU) 51, a read only memory (ROM) 52 and a random access memory (RAM) 53 are mutually connected via a bus 54.

An I/O interface 55 is also connected to the bus 54. An input section 56 constituted by, for example, a keyboard and a mouse, an output section 57 constituted by, for example, a display and a speaker are connected to the I/O interface 55. A storage section 58 constituted by, for example, hard disk and nonvolatile memory, a communication section 59 constituted by, for example, a network interface, and a drive 60 which drives a removable medium 61 are connected to the I/O interface 55.

In the computer of the above-described configuration, the series of process steps is executed by, for example, the CPU 51 loading the program stored in the storage section 58 to the RAM 53 via the I/O interface 55 and the bus 54 and causing the program to be executed.

The program to be executed by the CPU 51 is, for example, recorded in the removable medium 61 or provided via a wired or wireless transmission medium, such as a local area network, the Internet and digital broadcasting, and is installed in the storage section 58.

The program to be executed by the computer may be a time-series program in which process steps are executed in the order described in the specification or may be a program in which process steps are executed in parallel or upon request, e.g., when invoked.

The embodiments described above are illustrative only and various modifications may be made without departing from the spirit and scope of the present invention.

It should be understood by those skilled in the art that various modifications, combinations, sub-combinations and alterations may occur depending on design requirements and other factors insofar as they are within the scope of the appended claims or the equivalents thereof.

What is claimed is:

1. A display control unit comprising:
a determining section which determines a type of content to be reproduced in a case in which the content to be reproduced is switched between 2D content and 3D content, the 2D content containing video data of 2D images and the 3D content containing video data of images for the left eye and images for the right eye;
a setting section which, for the 2D content, displays 2D images contained in the video data and, for the 3D content, sets a 2D display mode, in which either the images for the left eye or the images for the right eye are displayed, as a display mode of the content to be reproduced;
a reproducing section which reproduces the content to be reproduced such that the content is displayed in the 2D display mode; and
a display control section which, when it is determined that the type of content to be reproduced is 3D content, displays type information which indicates that the type of the content is 3D content while the content to be reproduced is displayed in the 2D display mode on the basis of data obtained through reproduction by the reproducing section.

2. The display control unit according to claim 1, wherein:
in response to user instructions after the type information is displayed, the setting section sets a 3D display mode in which images for the left eye and images for the right eye contained in the video data of the 3D content are displayed;
the reproducing section reproduces the content to be reproduced such that the content is displayed in the 3D display mode; and
the display control section displays the images for the left eye and the images for the right eye on the basis of data obtained through reproduction by the reproducing section.

3. The display control unit according to claim 2, wherein the setting section sets the 2D display mode when the reproduction of the content to be reproduced which is the 3D content ends.

4. The display control unit according to claim 1, wherein the setting section sets the 2D display mode when the display control unit is turned on.

5. The display control unit according to claim 1, wherein the content to be reproduced is broadcast content and the setting section sets the 2D display mode when a channel on which the broadcast content is received is changed.

6. A display control method comprising the steps of:
determining a type of content to be reproduced in a case in which the content to be reproduced is switched between 2D content and 3D content, the 2D content containing video data of 2D images and the 3D content containing video data of images for the left eye and images for the right eye;
for the 2D content, displaying 2D images contained in the video data and, for the 3D content, setting a 2D display mode, in which either the images for the left eye or the images for the right eye are displayed, as a display mode of the content to be reproduced;
reproducing the content to be reproduced such that the content is displayed in the 2D display mode; and
when it is determined that the type of content to be reproduced is 3D content, displaying type information which indicates that the type of the content is 3D content while the content to be reproduced is displayed in the 2D display mode on the basis of data obtained through reproduction.

7. A program which causes a computer to execute a process including the steps of:
determining a type of content to be reproduced in a case in which the content to be reproduced is switched between 2D content and 3D content, the 2D content containing video data of 2D images and the 3D content containing video data of images for the left eye and images for the right eye;
for the 2D content, displaying 2D images contained in the video data and, for the 3D content, setting a 2D display mode, in which either the images for the left eye or the images for the right eye are displayed, as a display mode of the content to be reproduced;
reproducing the content to be reproduced such that the content is displayed in the 2D display mode; and
when it is determined that the type of content to be reproduced is 3D content, displaying type information which indicates that the type of the content is 3D content while the content to be reproduced is displayed in the 2D display mode on the basis of data obtained through reproduction.
